(19) United States
(12) Patent Application Publication
(10) Pub. No.: US 2014/0029915 A1
(43) Pub. Date: Jan. 30, 2014

(54) VIDEO-PREVIEWING METHODS AND SYSTEMS FOR PROVIDING PREVIEW OF A VIDEO AND MACHINE-READABLE STORAGE MEDIUMS THEREOF

(71) Applicant: WISTRON CORP., New Taipei City (TW)

(72) Inventor: Zhao-Yuan Lin, New Taipei City (TW)

(21) Appl. No.: 13/940,084

(22) Filed: Jul. 11, 2013

(30) Foreign Application Priority Data
Jul. 27, 2012 (TW) 101127130

(51) Int. Cl. H04N 5/91

(52) U.S. Cl. CPC H04N 5/91
USPC 386/241

(57) ABSTRACT

Video previewing methods for electronic devices with a touch-sensitive display unit for providing preview of a video to be played are provided. First, a resolution of the touch-sensitive display unit of the electronic device is detected. Thereafter, a preview screen is generated on the touch-sensitive display unit according to the resolution of the touch-sensitive display unit, wherein the preview screen includes M level frame bars and each of the M level frame bars displays N video frames, and N for each of the M level frame bars is determined based on the resolution of the touch-sensitive display unit, where M≧1 and N≧1.

### CROSS REFERENCE TO RELATED APPLICATIONS

This application claims priority of Taiwan Application No. 101127130, filed on Jul. 27, 2012, and the entirety of which is incorporated by reference herein.

### BACKGROUND

1. Field of the Disclosure

The disclosure generally relates to video-previewing systems and video-previewing methods thereof, and more particularly, to frame-based video-previewing systems and video-previewing methods using the same.

2. Description of the Related Art

Recently, because of the rapidly grow of touchable equipments, electronic devices, such as smart phones, PDAs, tablet PCs or Ultra Mobile PCs (UMPCs), are equipped with a touch screen which is directly touchable may be provided as a main input device for users to play or preview the video. Users of the handheld devices can slide their fingers to drag a progress bar to find a starting position in the video where they want to start the video browsing. For seeking or jumping to a special video frame of the video, however, no quick method can be provided yet such that users may spend a lot of time to seek for the video frame that they want to review, thus lacking of capability of quickly viewing for the digital video data.

In addition, for current video player, the video at the specific time point has to be clicked by fingers so as to browse the video. Movements of the fingers, however, are often inconsistent with the proportion of the progress bar that it moves, making the desired time point of the video can not be clicked exactly.

### BRIEF SUMMARY

Accordingly, embodiments of the disclosure provide video previewing methods and systems for providing quickly previewing of a video during it is playing.

In one aspect of the disclosure, a video-previewing method for providing preview of a video to be played for an electronic device with a touch-sensitive display is provided. The method includes the following steps. First, a resolution of the touch-sensitive display unit of the electronic device is detected. A preview screen corresponding to the video is then generated on the touch-sensitive display unit according to the resolution of the touch-sensitive display unit, wherein the preview screen includes M level frame bars and each of the M level frame bars displays N video frames, wherein the value of the frame number N representing the number of video frames for each of the M level frame bars is determined based on the resolution of the touch-sensitive display unit, where M≧1 and N≧1.

In another aspect of the invention, a video-previewing system for providing preview of a video to be played is provided which includes a touch-sensitive display unit, a parameter generation unit and a preview screen generation unit. The touch-sensitive display unit has a resolution. The parameter generation unit is arranged for detecting the resolution of the touch-sensitive display unit. The preview screen generation unit which is coupled to the parameter generation unit and the touch-sensitive display unit is arranged for generating a preview screen corresponding to the video on the touch-sensitive display unit according to the resolution of the touch-sensitive display unit detected by the parameter generation unit, wherein the preview screen includes M level frame bars and each of the M level frame bars displays N video frames, wherein the value of the frame number N representing the number of video frames for each of the M level frame bars is determined based on the resolution of the touch-sensitive display unit, where M≧1 and N≧1.

Video-previewing methods may take the form of a program code embodied in a tangible media. When the program code is loaded into and executed by a machine, the machine becomes an apparatus for practicing the disclosed method.

### BRIEF DESCRIPTION OF DRAWINGS

The disclosure can be more fully understood by reading the subsequent detailed description and examples with references made to the accompanying drawings, wherein:

FIG. 1 is a schematic diagram illustrating an embodiment of a video-previewing system of the disclosure;

FIG. 2 is a flowchart of an embodiment of a video-previewing method of the disclosure;

FIG. 3 is a flowchart of another embodiment of a video-previewing method of the disclosure;

FIGS. 4A and 4B show a flowchart of another embodiment of a video-previewing method of the disclosure;

FIG. 5 is a schematic diagram illustrating an embodiment of an example of a level-based preview screen of the disclosure; and

FIGS. 6A to 6C are schematic diagrams illustrating other embodiments of examples of a level-based preview screen of the disclosure.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

Current video players can be divided into two kinds of representations, one kind for frame-based players while the other kind for non-frame-based players. The non-frame-based player provides a simple time axis for users to make the video scene selection. Although the user interface for the non-frame-based player is simple and the playing speed for which is quicker than that of the frame-based player, users may be unable to observe changes in each time scene easier such that users may be unable to quickly seek for a desired video frame for playing. The frame-based player intercepts the video frames at specific time points in the video to present a scene view for each section to the users such that the users can have a rough overview of the video. Therefore, embodiments of the invention provide frame-based video previewing and playing devices which can present a level-based preview screen with multiple levels corresponding to the video during the video is playing, wherein the number of levels and the number of video frames displayed on the level-based preview screen can dynamically varied according to the resolution of the playing device and the video length of the video, thus providing effective video data indexes with multiple levels and achieving a goal for previewing and searching for the video data quickly.

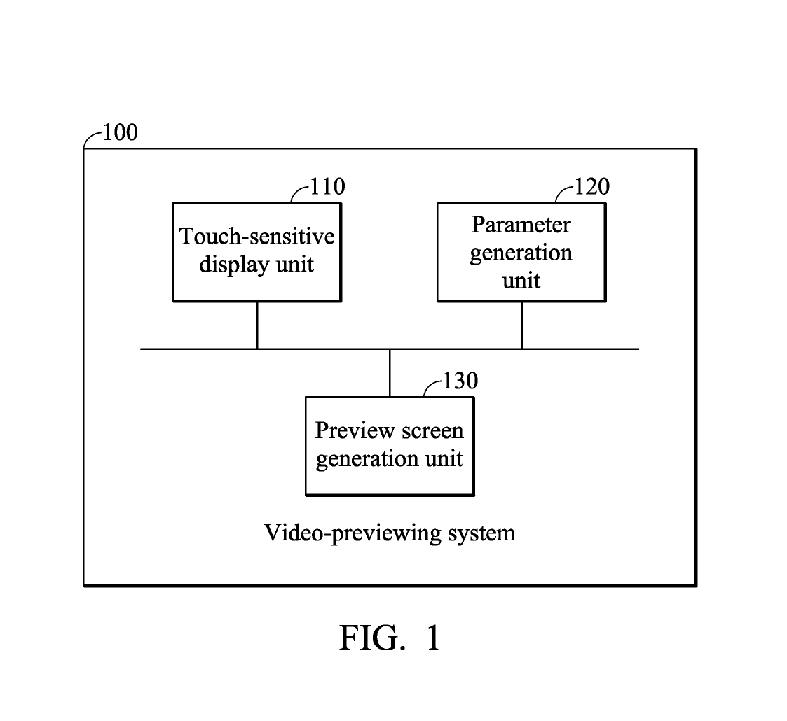

FIG. 1 is a schematic diagram illustrating an embodiment of a video-previewing system for providing preview of a video to be played of the disclosure. The video-previewing system 100 can be used in an electronic device, such as a PDA (Personal Digital Assistant), a smart phone, a mobile phone, an MID (Mobile Internet Device, MID), a laptop computer, a car computer, a digital camera, a multi-media player, a game device, or any other type of mobile computational device, however, it is to be understood that the invention is not limited thereto. The video-previewing system 100 includes a touch-sensitive display unit 110, a parameter generation unit 120, and a preview screen generation unit 130. It is understood that, in some embodiments, the touch-sensitive display unit 110 may be integrated with a touch-sensitive device (not shown). The touch-sensitive device has a touch-sensitive surface comprising sensors in at least one dimension to detect contact and movement of at least one object (input tool), such as a pen/stylus or finger near or on the touch-sensitive surface. The touch-sensitive display unit 110 can also display data, such as texts, figures, interfaces, and/or information. The touch-sensitive display unit 110 can have a resolution for indicating a display range for the touch-sensitive display unit 110. For example, the touch-sensitive display unit 110 may have a resolution of 800*600, which indicates that the pixel amount of the screen width of its screen is 800 and the pixels amount of the screen height of its screen is 600.

The parameter generation unit 120 can detect and collect parameters related to the video-previewing system 100 and videos, such as the resolution of the touch-sensitive display unit 110 and the video length of the video, and then generate required parameters according to those related parameters. For example, the parameters may comprise a parameter representing an expected frame size, a parameter minimum frame range (MIFR), a parameter maximum frame range (MAFR), a parameter maximum frame count (MFC) and a count value CFC and so on, wherein the parameter MIFR represents an expected value for a minimum expected gap between each two of the video frames, the parameter MAFR represents an expected value for a maximum expected gap between each two of the video frames, the parameter MFC represents the maximum frame amount which is calculated for each frame bar in each level on the screen of the touch-sensitive display unit 110, and the count value CFC represents/determines the number of frame levels and the size of frame segments. For example, if MIFR is 10 and MAFR is 20, the minimum expected gap between each two of the divided video frames is set to be at least 10 seconds while the maximum expected gap between each two of the divided video frames is set to be less than 20 seconds. In other words, the frame gap between each two of the video frames is to be set between 10 and 20 seconds. Note that, the width of the resolution of the touch-sensitive display unit 110 is divided by a first parameter representing the expected frame size to obtain the parameter MFC. In one embodiment, it is assumed that a target frame size of each touchable frame is at least 100 pixels and it is with a format of 16:9. For example, if the width of the resolution of the touch-sensitive display unit 110 is 800 and the first parameter is set to 100 (pixels), the parameter MFC= 800/100=8, which means that the frame bar displayed by each level on the screen of the touch-sensitive display unit 110 at most have 8 frames. Additionally, the count value CFC (Current Frame Count) can be defined as shown in formula (1) below:

CFC=Length/MIFR∥CFC=Length/MAFR (1)

, wherein Length represents the video length in unit of second.

The preview screen generation unit 130 which is coupled to the parameter generation unit 120 and the touch-sensitive display unit 110 can dynamically adjust the number of video frames displayed in the frame bar of each level according to the video length of the video to be played. If the video length is too long, the preview screen may have/generate a second level frame bar and a third level frame bar to show the video frames in each level frame bar. The preview screen generation unit 130 may further divide the video into the N video frames based on the parameter MIFR. If the number of divided video frames has exceeded the maximum frame amount of the video MFC, the preview screen generation unit 130 may then divide the video into the video frames based on the parameter MAFR. Similarly, if the number of divided video frames which are divided by the parameter MAFR has exceeded the maximum frame amount of the video MFC, the preview screen generation unit 130 may further determine whether the level three has reached and if not, increase the level by one and distribute the video frames in the lower level with the maximum frame count MFC. Thereafter, one of the distributed video frames of the lower level will be utilized to extend a next level and the aforementioned determinations of whether the number of divided video frames has exceeded the maximum frame amount of the video MFC based on the parameters MIFR and MAFR will also be performed on this level to see if a next level should be further generated. The level-based video-previewing method of the present invention will be discussed further in the following paragraphs.

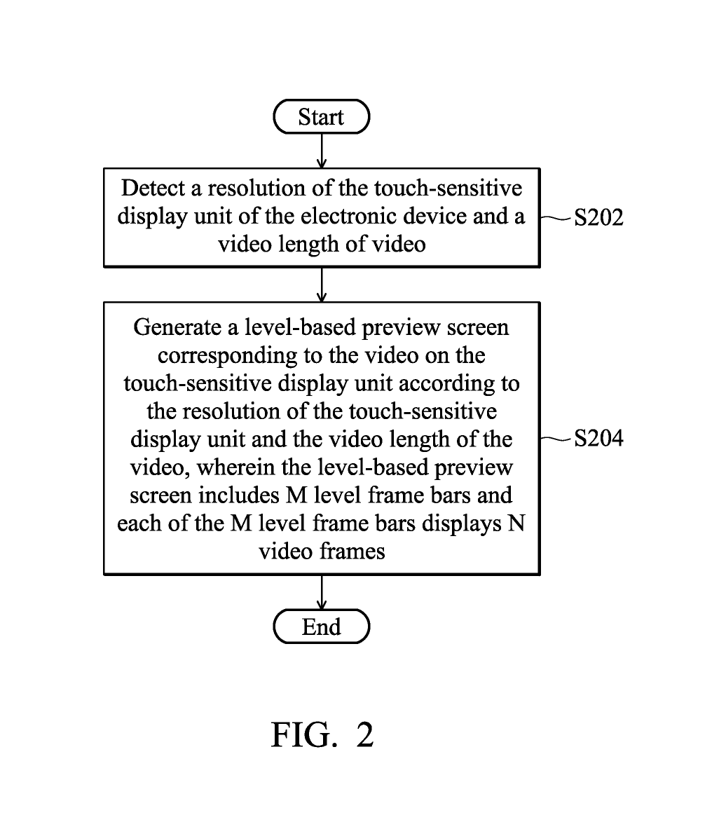

FIG. 2 is a flowchart of an embodiment of a video-previewing method of the disclosure. The video-previewing method can be used in an electronic device, such as a Television, a laptop computer, or portable devices, such as a PDA, a smart phone, a mobile phone, an MID, a mini-laptop computer, a tablet computer or any other type of handheld device, however, it is to be understood that the invention is not limited thereto. It is understood that, in this embodiment, the electronic device may include a touch-sensitive display unit 110, wherein the touch-sensitive display unit 110 can display a level-based preview screen for a video to be played during which it is playing.

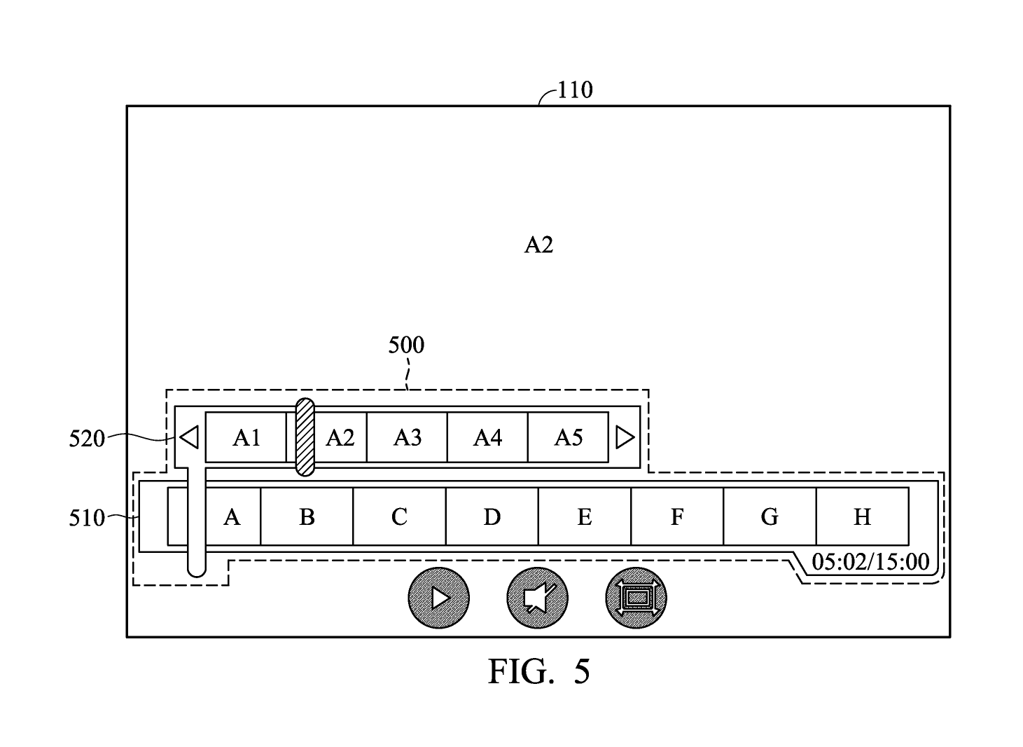

In step S202, the parameter generation unit 120 first detects the resolution of the touch-sensitive display unit 110 of the electronic device and the video length of the video. In step S204, the preview screen generation unit 130 generates a preview screen corresponding to the video on the touch-sensitive display unit 110 according to the resolution of the touch-sensitive display unit 110 and the video length of the video detected by the parameter generation unit 120, wherein the preview screen is a level-based preview screen which includes M level frame bars and each of the M level frame bars displays N video frames, where M≧1 and N≧1, wherein the value of the frame number N is determined based on the resolution of the touch-sensitive display unit while the value of the level number M is determined based on the video length of the video. In other words, the level number M represents the number of levels of the preview screen, which at least be one, wherein the value of the level number M is varied according to the video length of the video, e.g. the value of the level number M of the preview screen for a video with a video length of 160 seconds is different than that for a video with a video length of 1800 seconds. The frame number N represents the number of video frames displayed on each level, wherein the frame number N of video frames may be set different in each level according to the resolution of the touch-sensitive display unit 110, e.g. the frame number N of the video frames set in each level of the preview screen for a touch-sensitive display unit with a resolution of 800*600 is different than that for a touch-sensitive display unit with a resolution of 1280*768. For example, M=2 means that the preview screen has two level frame bars and the frame number N displayed on each level can be set separately. For example, please referring to FIG. 5, FIG. 5 is a schematic diagram illustrating an embodiment of an example of a level-based preview screen of the disclosure. As shown in FIG. 5, the level-based preview screen 500 includes two level frame bars 510 and 520 in which the first level frame bar 510 displays eight video frames A to H while the second level frame bar 520 displays five video frames A1 to A5, which are sub-frames divided from the video frame A. Similarly, when users select the video frame with the content B, the second level frame bar 520 may display five video frames B1 to B5, which are sub-frames divided from the video frame B. Thus, users can perform a search operation and set the location of the initial video frame to be previewed quickly through the level-based preview screen generated by the preview screen generation unit 130.

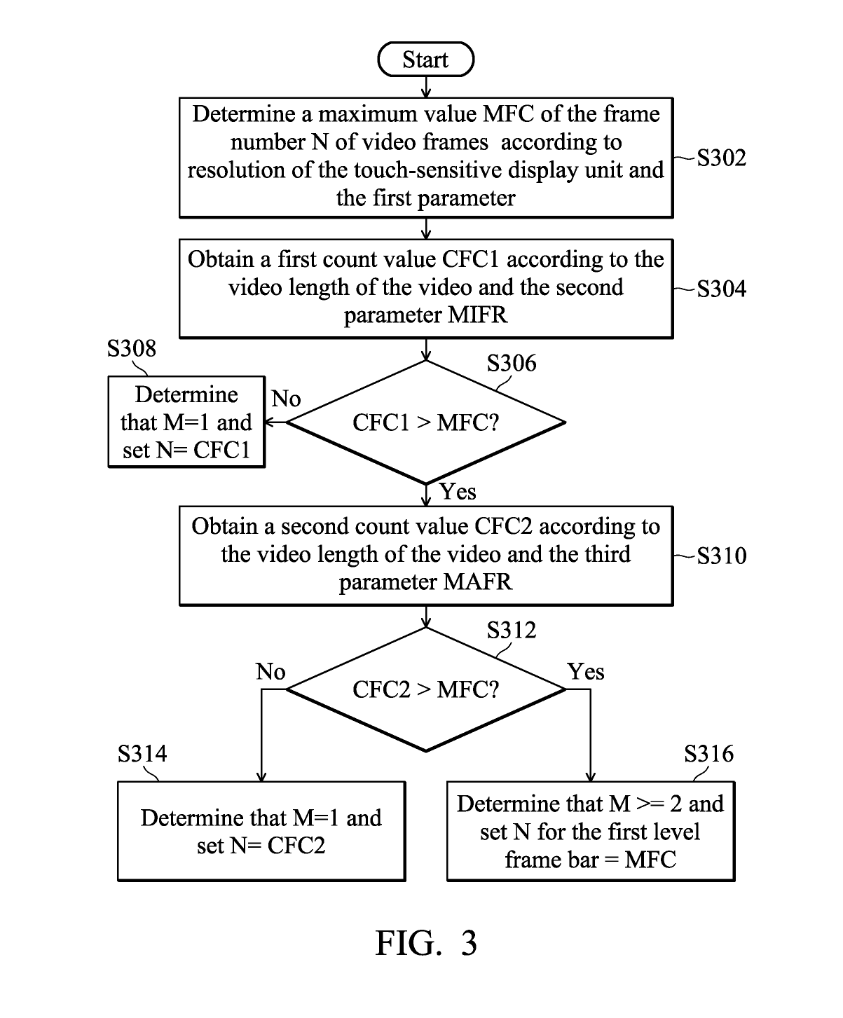

FIG. 3 is a flowchart of another embodiment of a video-previewing method of the disclosure for illustrating how to determine the level number M representing the number of levels and the frame number N representing the number of frames for each of the level number M levels based on the resolution of the touch-sensitive display unit 110 and the video length of the video. The video-previewing method can be used in an electronic device, such as a Television, a laptop computer, or portable devices, such as a PDA, a smart phone, a mobile phone, an MID, a mini-laptop computer, a tablet computer or any other type of handheld device, however, it is to be understood that the invention is not limited thereto. In this embodiment, first, second and third parameters are first provided, wherein the first parameter represents an expected frame resolution, the second parameter MIFR represents a minimum expected gap between each two of the N video frames and the third parameter MAFR represents a maximum expected gap between each two of the N video frames. In the following embodiments, it is assumed that the expected frame resolution is set to 100 pixels and each frame is with a format of 16:9, the minimum expected gap between each two of the video frames is set to 10 seconds and the maximum expected gap between each two of the video frames is set to 20 seconds, but the invention is not limited thereto. In one embodiment, the video-previewing system 100 may further include a user interface for providing users to input or modify default values of the above-mentioned first, second and third parameters.

In step S302, the parameter generation unit 120 determines a maximum value of the frame number N, MFC, i.e. the maximum number of video frames, according to the resolution of the touch-sensitive display unit 110 and the first parameter. In this step, the parameter generation unit 120 can divide the width of the touch-sensitive display unit 110 by the first parameter (i.e. 100 pixels) to obtain the maximum value MFC of the frame number N.

After obtaining the maximum value MFC of the frame number N, the preview screen generation unit 130 further determines the value of the level number M, i.e. the number of levels for the level-based preview screen, according to the video length of the video, the second parameter MIFR and the third parameter MAFR.

In step S304, the preview screen generation unit 130 obtains a first count value CFC1 according to the video length of the video and the second parameter MIFR and then, in step S306, determines whether the first count value CFC1 has exceeded the maximum value MFC of the frame number N. In this step, the video length of the video is first divided by the second parameter MIFR to obtain the first count value CFC1 and it is further determined whether the first count value CFC1 has exceeded the maximum value MFC of the frame number N. Note that the first count value CFC1 is determined as not exceeding the maximum value MFC of the frame number N if the first count value CFC1 is less than or equal to the maximum value MFC of the frame number N. When the first count value CFC1 has not exceeded the maximum value MFC of the frame number N (No in step S306), meaning that the number of divided video frames which are divided using the parameter MIFR has not exceeded the maximum allowed number of video frames, in step S308, the preview screen generation unit 130 determines that the value of the level number M is set to be 1 and sets the value of the frame number N to the first count value CFC1. In other words, the level-based preview screen may only have the first level frame bar and the number of video frames displayed on the first level frame bar is the first count value CFC1, wherein the size of each video frame is obtained by dividing the video length by the second parameter MIFR.

Contrarily, when the first count value CFC1 has exceeded the maximum value MFC of the frame number N (Yes in step S306), meaning that the number of divided video frames which are divided using the parameter MIFR has exceeded the maximum allowed number of video frames and re-calculation are required, then, in step S310, the preview screen generation unit 130 further obtains a second count value CFC2 according to the video length of the video and the third parameter MAFR and, in step S312, determines whether the second count value CFC2 has exceeded the maximum value of the frame number N. Similarly, in this step, the preview screen generation unit 130 may divide the video length of the video by the parameter MAFR to obtain the second count value CFC2.

When the second count value CFC2 has not exceeded the maximum value MFC of the frame number N (No in step S312), meaning that the number of divided video frames which are divided using the parameter MAFR has not exceeded the maximum allowed number of video frames, in step S314, the preview screen generation unit 130 determines that the value of the level number M is set to be 1 and sets the value of the frame number N to the second count value CFC2. In other words, the level-based preview screen may only have the first level frame bar and the number of video frames displayed on the first level frame bar is the second count value CFC2, wherein the size of each video frame is obtained by dividing the video length by the third parameter MAFR.

Contrarily, when the second count value CFC2 has exceeded the maximum value MFC of the frame number N (Yes in step S312), meaning that the number of the divided video frames which are divided using the parameter MAFR has exceeded the maximum allowed number of video frames and at least two levels are required, then, in step S316, the preview screen generation unit 130 determines that the value of the level number M is set to be at least 2 and sets the value of the frame number N for the first level frame bar among the M level frame bars to the maximum value MFC of the frame number N. In other words, the level-based preview screen generated by the preview screen generation unit 130 may have at least first and second level frame bars and the number of video frames displayed on the first level frame bar is the maximum value MFC of the frame number N, wherein the size of each video frame is obtained by dividing the video length by the maximum value MFC of the frame number N. It is to be noted that, for displaying the level-based preview screen easily, the preview screen generation unit 130 configures that the maximum value of the frame number N is set to be 3, that is, at most three levels can be displayed on the level-based preview screen regardless the video length of the video.

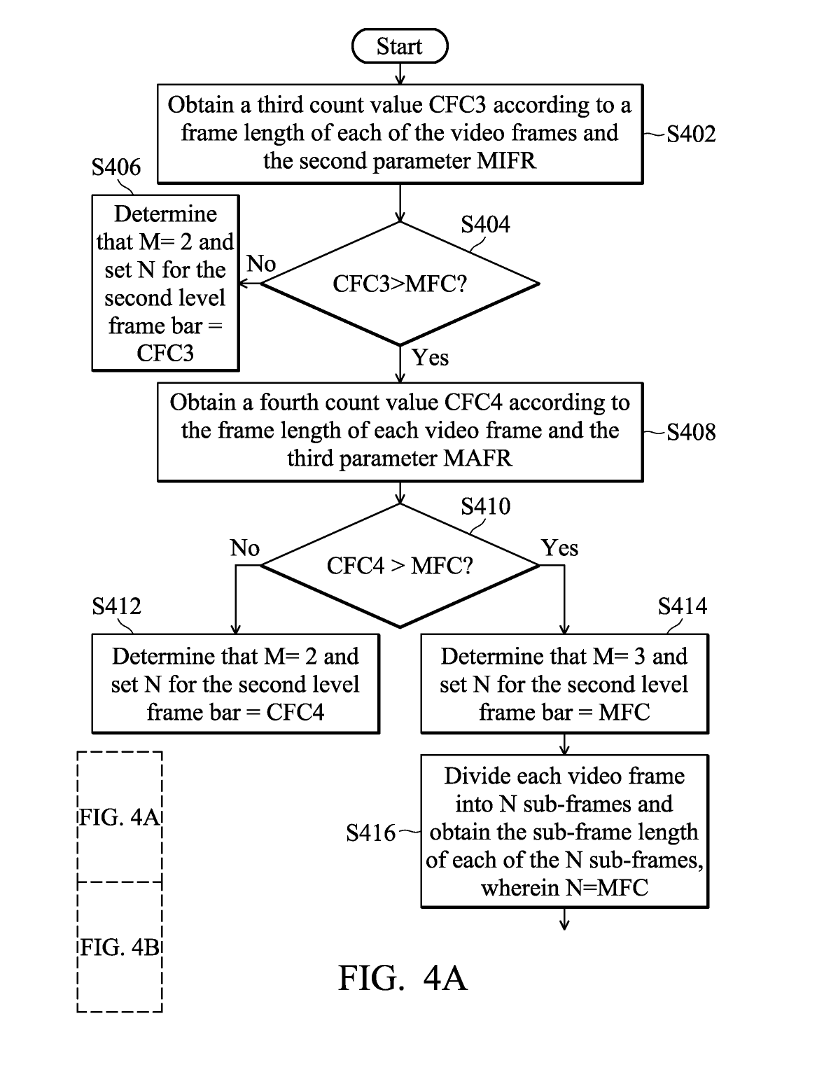

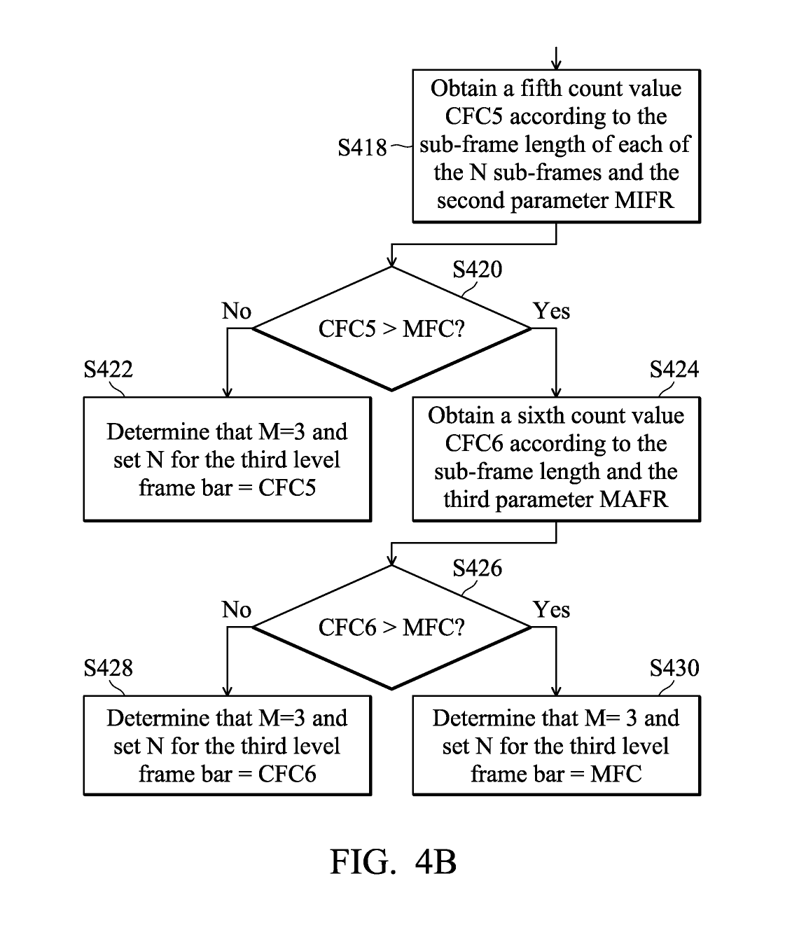

After it is calculated that the level-based preview screen includes at least two levels, which means that each video frame is required to be divided into sub-frames, the video length of each video frame in the first level is further be utilized to perform subsequent determination. Please refer to FIGS. 4A and 4B.

FIGS. 4A and 4B show a flowchart of another embodiment of a video-previewing method of the disclosure for illustrating how to determine next level and the value of the number of frames N in the next level for each video frame of the first level of the level-based preview screen based on the resolution of the touch-sensitive display unit 110 and the video length of the video. The video-previewing method can be used in an electronic device, such as a Television, a laptop computer, or portable devices, such as a PDA, a smart phone, a mobile phone, an MID, a mini-laptop computer, a tablet computer or any other type of handheld device, however, it is to be understood that the invention is not limited thereto. In this embodiment, it is assumed that the video is divided into N video frames based on the video length of the video, wherein N is set to be the maximum value MFC of the frame number N.

In step S402, the preview screen generation unit 130 obtains a third count value CFC3 according to a frame length of each of the N frames and the second parameter MIFR and then, in step S404, determines whether the third count value CFC3 has exceeded the maximum value MFC of the frame number N. In this step, the preview screen generation unit 130 divides the frame length of each video frame by the second parameter MIFR to obtain the third count value CFC3 and determines whether the third count value CFC3 has exceeded the maximum value MFC of the frame number N. When the third count value CFC3 has not exceeded the maximum value MFC of the frame number N (No in step S404), meaning that the number of the divided sub-frames which are divided using the parameter MIFR has not exceeded the maximum allowed number of video frames, in step S406, the preview screen generation unit 130 determines the value of the level number M is set to be 2 and sets the value of the frame number N for the second level frame bar among the M level frame bars to the third count value CFC3. In other words, the level-based preview screen generated by the preview screen generation unit 130 may have both the first and second level frame bars and the number of video frames for each frame displayed on the second level frame bar is the third count value CFC3, wherein the size of each sub-frame is obtained by dividing the video length by the second parameter MIFR.

Contrarily, when the third count value CFC3 has exceeded the maximum value MFC of the frame number N (Yes in step S404), meaning that the number of the divided sub-frames which are divided using the parameter MIFR has exceeded the maximum allowed number of video frames and re-calculation are required, then, in step S408, the preview screen generation unit 130 further obtains a fourth count value CFC4 according to the video length of the video and the third parameter MAFR and, in step S410, determines whether the fourth count value CFC4 has exceeded the maximum value of the frame number N. Similarly, in this step, the preview screen generation unit 130 may divide the video length of the video by the parameter MAFR to obtain the fourth count value CFC4.

When the fourth count value CFC4 has not exceeded the maximum value MFC of the frame number N (No in step S410), meaning that the number of the divided video frames which are divided using the parameter MAFR has not exceeded the maximum allowed number of video frames, in step S412, the preview screen generation unit 130 determines the value of the level number M is set to be 2 and sets the value of the frame number N for the second level frame bar among the M level frame bars N to the fourth count value CFC4. In other words, the level-based preview screen may have both the first and second level frame bars and the number of video frames displayed on the second level frame bar is the fourth count value CFC4, wherein the length of each sub-frame is obtained by dividing the video length by the third parameter MAFR.

Contrarily, when the fourth count value CFC4 has exceeded the maximum value MFC of the frame number N (Yes in step S410), meaning that the number of the divided video frames which are divided using the parameter MAFR has exceeded the maximum allowed number of video frames and a level three is required, then, in step S414, the preview screen generation unit 130 determines the value of the level number M is set to be 3 and sets the value of the frame number N for the second level frame bar among the M level frame bars to the maximum value MFC of the frame number N.

In other words, the level-based preview screen generated by the preview screen generation unit 130 may have at least first, second and three level frame bars and the number of video frames displayed on the first and second level frame bars are the maximum value MFC of the frame number N, wherein the length of each video frame is obtained by dividing the video length by the maximum value MFC of the frame number N.

After it is calculated that the level-based preview screen includes the third level, which means that each sub-frame is required to be divided into sub-frames, the sub-frame length of each video sub-frame in the second level is further be utilized to perform subsequent determination.

In step S416, the preview screen generation unit 130 divides the video frame into N sub-frames and obtains the sub-frame length of each of the N sub-frames based on the video length of the video, wherein N is set to be the maximum value MFC of the frame number N.

In step S418, the preview screen generation unit 130 obtains a fifth count value CFC5 according to the sub-frame length of each of the N sub-frames and the second parameter MIFR and then, in step S420, determines whether the fifth count value CFC5 has exceeded the maximum value MFC of the frame number N. In this step, the preview screen generation unit 130 divides the sub-frame length of each of the N sub-frames by the second parameter MIFR to obtain the fifth count value CFC5 and determines whether the fifth count value CFC5 has exceeded the maximum value MFC of the frame number N. When the fifth count value CFC5 has not exceeded the maximum value MFC of the frame number N (No in step S420), meaning that the number of the divided sub-frames which are divided using the parameter MIFR has not exceeded the maximum allowed number of video frames, in step S422, the preview screen generation unit 130 determines the value of the level number M is set to be 3 and sets the value of the frame number N for the third level frame bar among the M level frame bars to the fifth count value CFC5. In other words, the level-based preview screen generated by the preview screen generation unit 130 may have the first, second and third level frame bars and the number of video frames for each sub-frame displayed on the third level frame bar is the fifth count value CFC5, wherein the length of each sub-frame is obtained by dividing the sub-frame length by the second parameter MIFR.

Contrarily, when the fifth count value CFC5 has exceeded the maximum value MFC of the frame number N (Yes in step S420), meaning that the number of the divided sub-frames which are divided using the parameter MIFR has exceeded the maximum allowed number of video frames and re-calculation is required, then, in step S424, the preview screen generation unit 130 further obtains a sixth count value CFC6 according to the sub-frame length and the third parameter MAFR and, in step S426, determines whether the fifth count value CFC6 has exceeded the maximum value of the frame number N. Similarly, in this step, the preview screen generation unit 130 may divide the sub-frame length of the sub-frame by the parameter MAFR to obtain the sixth count value CFC6.

When the sixth count value CFC6 has not exceeded the maximum value MFC of the frame number N (No in step S426), meaning that the number of the divided video frames which are divided using the parameter MAFR has not exceeded the maximum allowed number of video frames, in step S428, the preview screen generation unit 130 determines the value of the level number M is set to be 3 and sets the value of the frame number N for the third level frame bar among the M level frame bars to the sixth count value CFC6.

In other words, the level-based preview screen may have the first, second and third level frame bars and the number of video frames displayed on the third level frame bar is the sixth count value CFC6, wherein the length of each sub-frame is obtained by dividing the sub-frame length by the third parameter MAFR.

Contrarily, when the sixth count value CFC6 has exceeded the maximum value MFC of the frame number N (Yes in step S426), meaning that the number of the divided video frames which are divided using the parameter MAFR has exceeded the maximum allowed number of video frames and a maximum number of levels three has reached, then, in step S430, the preview screen generation unit 130 determines the value of the level number M is set to be 3 and sets the value of the frame number N for the third level frame bar among the M level frame bars to the maximum value MFC of the frame number N.

It is to be noted that, during the calculation of the number of frames for the third level frame bar, if the sub-frame is divided into the sub-frames using the parameter MIFR, the number of frames for the third level frame bar can be determined by using an unconditional cutting method to round down the calculated count value after the decimals; and if the sub-frame is divided into the sub-frames using the parameter MIFR, the number of frames for the third level frame bar can be determined by using an unconditional rounding-up method to round up the calculated count value after the decimals.

For explanation, specific embodiments are illustrated in the following to explain the detailed process of a video-previewing method of the invention and how to determine the number of levels and the number of the frames for the level-based preview screen, and those skilled in the art will understand that these specific embodiments are used for explanation only and the invention is not limited thereto.

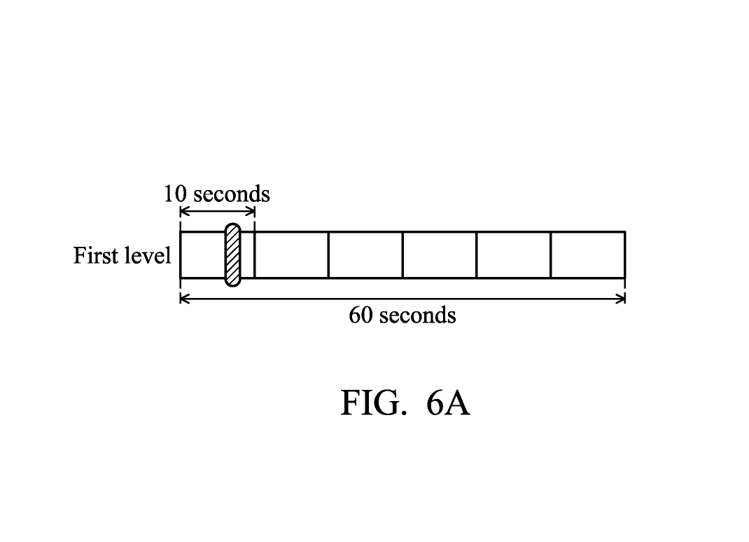

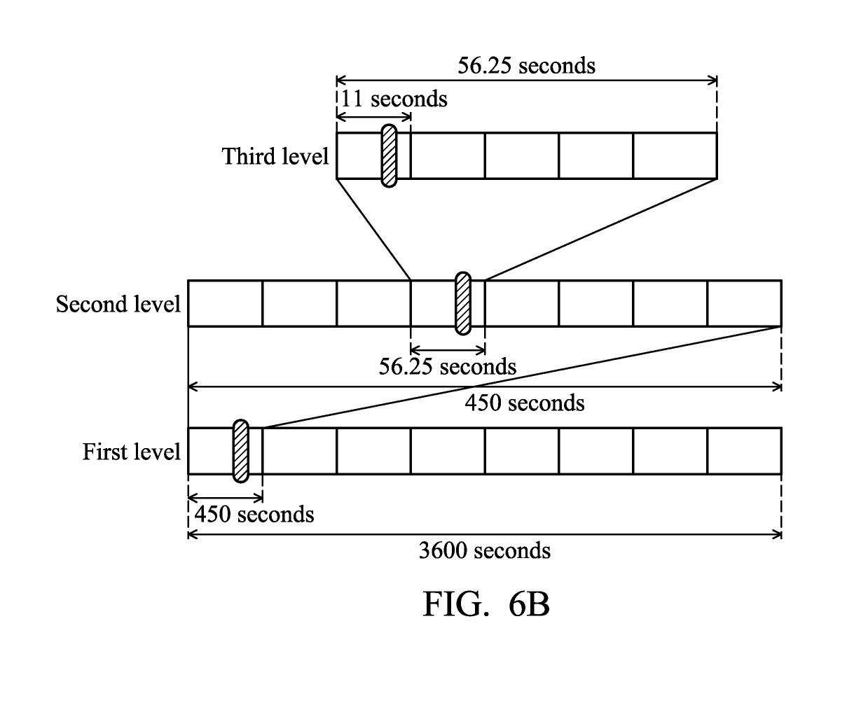

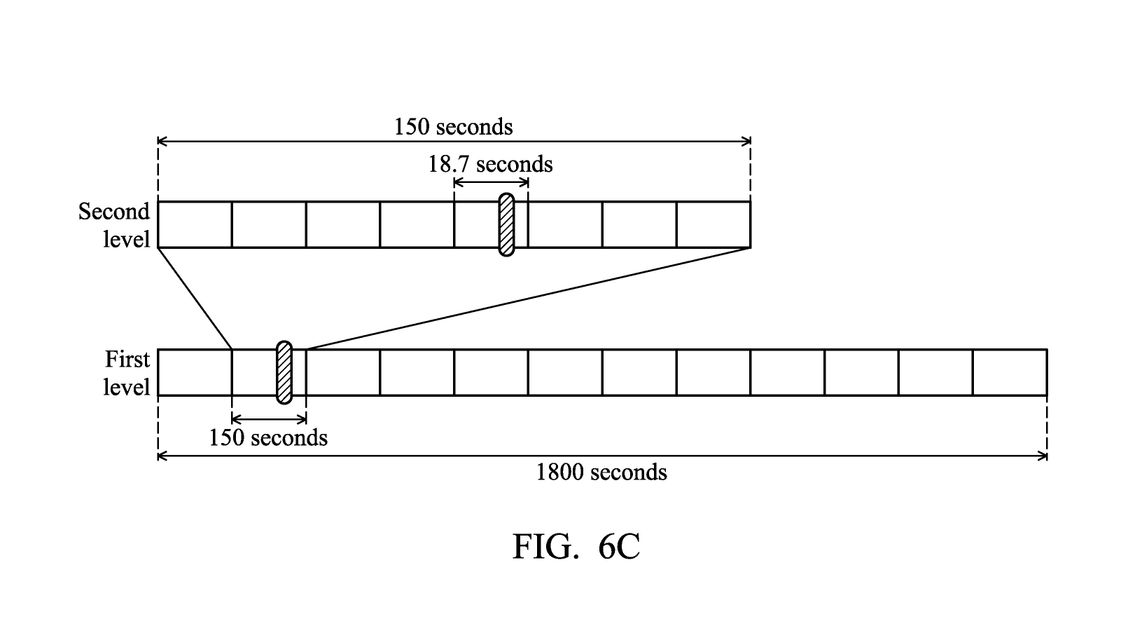

In the first embodiment, assume that the resolution of the electronic device is defined as 800*480 and the video length is defined as 600 seconds, the value of the parameter MFC can be obtained by following formula: MFC= 800/100=8, which means that each level can display at most eight video frames. It is then calculated the number of levels of the level-based preview screen. As the video length is of 60 seconds, the count value CFC can be calculated by following formula using the parameter MIFR (i.e. 10): CFC= 60/10=6. Because the value 6 is less than the MFC, it is determined that the level-based preview screen corresponding to the video has only the first level and the number of frames thereof is set to 6, wherein each frame is with a length of 10 seconds. Thus, when the video is being previewed, a level-based preview screen with only one level which contains six video frames will be displayed for selection by the users, as shown in FIG. 6A.

In the second embodiment, assume that the resolution of the electronic device is defined as 800*480 and the video length is defined as 3600 seconds, the value of the parameter MFC can be obtained by following formula: MFC= 800/100=8, which means that each level can display at most eight video frames. It is then calculated the number of levels of the level-based preview screen. As the video length is of 3600 seconds, the first count value CFC1 can be calculated by following formula using the parameter MIFR: CFC1= 3600/10=360. Because the value 3600 has exceeded the MFC, it is determined to calculate a second count value CFC2 by following formula using the parameter MAFR (i.e. 20): CFC2= 3600/20=180. As the value 180 has still exceeded the MFC, it means that the number of levels of the level-based preview screen at least be set to be 2. Accordingly, the video is divided into video frames by the MFC for the first level i.e., the number of frames for the first level is set to 8, and the video is divided into 8 video frames, each with a frame length of 450 seconds. Next, the frame length of one of the video frames in the first level (i.e. 450 seconds) is further utilized to determine the number of frames for the second level and to see if a third level is required.

Similarly, during the calculation of the number of frames of the second level, as the frame length is of 450 seconds, a third count value CFC3 can be calculated by following formula using the parameter MIFR: CFC3= 450/10=45. Because the value 450 has exceeded the MFC, it is determined to calculate a fourth count value CFC4 by following formula using the parameter MAFR: CFC4= 450/20=22.5. As the value 22.5 has still exceeded the value 8, it means that the number of levels of the level-based preview screen has exceeded two and the third level is required. Accordingly, each video frame in the second level is divided into video frames by the MFC, i.e., the number of frames for the second level is set to 8, and each video frame is divided into 8 sub-frames, each with a sub-frame length of 56.25 seconds. Next, the sub-frame length of one of the sub-frames in the second level (i.e. 56.25 seconds) is further utilized to determine the number of frames for the third level.

Similarly, during the calculation of the number of frames of the third level, as the sub-frame length is of 56.25 seconds, a fifth count value CFC5 can be calculated by following formula using the parameter MIFR: CFC5=56.25/10=5.25. Because the value 5.25 is less than the MFC, it is determined that the level-based preview screen corresponding to the video has the first, second and third levels and the number of frames for the third level is set to 5, wherein each frame is with a length of 11 seconds. Thus, when the video is being previewed, a level-based preview screen with three levels will be displayed for selection by the users, wherein the first level displays eight video frames, the second level displays eight video frames and the third level displays five video frames, as shown in FIG. 6B.

In some embodiments, when the level-based preview screen includes at least two levels, it can be displayed in different manners. In one embodiment, the first and second levels are simultaneously displayed for selection by the users while the third level is display only when one of the video frames of the second level has been selected if the third level exists. In another embodiment, the first, second and third levels are displayed for selection by the users at the same time.

In the third embodiment, assume that the resolution of the electronic device is defined as 1280*720 and the video length is defined as 1800 seconds, the parameter generation unit 120 can obtain the value of the parameter MFC by following formula: MFC= 1280/100=12, which means that each level can display at most twelve video frames. It is then calculated the number of levels of the level-based preview screen. As the video length is of 180 seconds, the first count value CFC1 can be calculated by following formula using the parameter MIFR: CFC1= 1800/10=180. Because the value 180 has exceeded the MFC, it is determined to calculate the second count value CFC2 by following formula using the parameter MAFR: CFC2= 1800/20=90. As the value 90 has still exceeded the MFC, it means that the number of levels of the level-based preview screen at least be set to be 2. Accordingly, the video is divided into video frames by the MFC for the first level, i.e., the number of frames for the first level is set to 12, and the video is divided into 12 video frames, each with a frame length of 150 seconds. Next, the frame length of one of the video frames in the first level (i.e. 150 seconds) is further utilized to determine the number of frames for the second level and to see if a third level is required.

Similarly, during the calculation of the number of frames of the second level, as the frame length is of 150 seconds, the third count value CFC3 can be calculated by following formula using the parameter MIFR: CFC3= 150/10=15. Because the value 15 has exceeded the MFC, it is determined to calculate the fourth count value CFC4 by following formula using the parameter MAFR: CFC4= 150/20=7.5. As the value 7.5 is less than the value 12, it is determined that the level-based preview screen corresponding to the video has the first and second levels and the number of frames for the second level is set to 8, each frame with a length of 18.7 seconds. Thus, when the video is being previewed, a level-based preview screen with two levels will be displayed for selection by the users, wherein the first level displays 12 video frames and the second level displays 8 video frames, as shown in FIG. 6C.

In the fourth embodiment, the display of the level-based preview screen may not be activated if the video length is less than the parameter MIFR (i.e. 10 seconds) or the parameter MAFR (i.e. 20 seconds). For example, if the video length is less than 10 seconds, the division of the video to the video frames is not required. If the video length is less than or equal to 20 seconds, the level-based preview screen may display only one level which contain two video frames displayed thereon.

In the fifth embodiment, it is assumed that the video length is too long such that the maximum expected gap between each two of the video frames defined by the parameter MAFR can not be matched even if the third level is presented. In this case, the sub-frame length of the sub-frame for the second level will all be used to divide the sub-frame into video frames, i.e., a level-based preview screen with three levels will be displayed and each of the first, second and third levels displays MFC video frames.

Therefore, according to the video-previewing method and related video-previewing system of the invention, optimized video frames to be cached can be determined during a video is playing to generate a level-based preview screen corresponding to the video automatically according to the video length of the video and the screen resolution of the touch-sensitive display unit, so as to provide fast previewing to quickly search video frames and/or change the operations for the video, making the use of video playing quicker and easier.

Video-previewing methods for use in an electronic device, or certain aspects or portions thereof, may take the form of a program code (i.e., executable instructions) embodied in tangible media, such as floppy diskettes, CD-ROMS, hard drives, or any other non-transitory machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A video-previewing method for providing preview of a video to be played for an electronic device with a touch-sensitive display unit, the method comprising:
detecting a resolution of the touch-sensitive display unit of the electronic device; and
generating a preview screen corresponding to the video on the touch-sensitive display unit according to the resolution of the touch-sensitive display unit, wherein the preview screen includes M level frame bars and each of the M level frame bars displays N video frames,
wherein the value of the frame number N of video frames for each of the M level frame bars is determined based on the resolution of the touch-sensitive display unit, where M≧1 and N≧1.

2. The video-previewing method of claim 1, further comprising:
detecting a video length of the video; and
determining the value of the level number M of levels according to the video length of the video.

3. The video-previewing method of claim 2, further comprising:
providing first, second and third parameters;
determining a maximum value of the N according to the resolution of the touch-sensitive display unit and the first parameter; and
determining the value of the level number M according to the video length of the video, the second parameter and the third parameter,
wherein the first parameter represents an expected resolution, the second parameter represents a minimum expected gap between each two of the N video frames and the third parameter represents a maximum expected gap between each two of the N video frames.

4. The video-previewing method of claim 3, wherein the step of determining the value of the level number M according to the video length of the video, the second parameter and the third parameters further comprises:
obtaining a first count value according to the video length of the video and the second parameter and determining whether the first count value has exceeded the maximum value of the frame number N;
when the first count value has not exceeded the maximum value of the frame number N, determining the value of the level number M is set to be 1 and setting the value of the frame number N to the first count value;
when the first count value has exceeded the maximum value of the frame number N, obtaining a second count value according to the video length of the video and the third parameter and determining whether the second count value has exceeded the maximum value of the frame number N; and
when the second count value has not exceeded the maximum value of the frame number N, determining the value of the level number M is set to be 1 and setting the value of the frame number N to the second count value.

5. The video-previewing of claim 4, further comprising:
when the second count value has exceeded the maximum value of the frame number N, determining the value of the level number M is set to be at least 2 and setting the value of the frame number N for a first level frame bar among the M level frame bars to the maximum value of the frame number N.

6. The video-previewing method of claim 5, wherein the maximum value of the level number M is set to be 3.

7. The video-previewing method of claim 5, further comprising:
dividing the video into the N video frames based on the video length of the video; and
obtaining a third count value according to a frame length of each of the N frames and the second parameter and determining whether the third count value has exceeded the maximum value of the frame number N;
when the third count value has not exceeded the maximum value of the frame number N, determining the value of the level number M is set to be 2 and setting the value of the frame number N for a second level frame bar among the M level frame bars to the third count value;
when the third count value has exceeded the maximum value of the frame number N, obtaining a fourth count value according to the video length of the video and the third parameter and determining whether the fourth count value has exceeded the maximum value of the frame number N; and
when the fourth count value has not exceeded the maximum value of the frame number N, determining the value of the level number M is set to be 2 and setting the value of the frame number N for the second level frame bar among the M level frame bars N to the fourth count value.

8. The video-previewing method of claim 7, further comprising:
when the fourth count value has exceeded the maximum value of the frame number N, determining the value of the level number M is set to be 3 and setting the value of the frame number N for the second level frame bar among the M level frame bars to the maximum value of the frame number N.

9. The video-previewing method of claim 8, further comprising:
dividing the video frame into N sub-frames based on the video length of the video; and
obtaining a fifth count value according to a sub-frame length of each of the N sub-frames and the second parameter and determining whether the fifth count value has exceeded the maximum value of the frame number N;
when the fifth count value has not exceeded the maximum value of the frame number N, determining the value of the level number M is set to be 3 and setting the value of the frame number N for a third level frame bar among the M level frame bars to the fifth count value;
when the fifth count value has exceeded the maximum value of the frame number N, obtaining a sixth count value according to the sub-frame length and the sixth parameter and determining whether the sixth count value has exceeded the maximum value of the frame number N; and
when the sixth count value has not exceeded the maximum value of the frame number N, determining the value of the level number M is set to be 3 and setting the third level frame bar among the M level frame bars to the sixth count value.

10. The video-previewing method of claim 9, further comprising:
when determining that the value of the level number M is set to be 3, determining the third level frame bar among the M level frame bars according to an unconditional cutting or an unconditional rounding-up method.

11. A video-previewing system for providing preview of a video to be played, the system comprising:
a touch-sensitive display unit, having a resolution;
a parameter generation unit, detecting the resolution of the touch-sensitive display unit; and
a preview screen generation unit coupled to the parameter generation unit and the touch-sensitive display unit, generating a preview screen corresponding to the video on the touch-sensitive display unit according to the resolution of the touch-sensitive display unit detected by the parameter generation unit, wherein the preview screen includes M level frame bars and each of the M level frame bars displays N video frames,
wherein the value of the frame number N of video frames for each of the M level frame bars is determined based on the resolution of the touch-sensitive display unit, where M≧1 and N≧1.

12. The video-previewing system of claim 11, wherein the parameter generation unit further detects a video length of the video and the preview screen generation unit further determines the value of the level number M of levels according to the video length of the video.

13. The video-previewing system of claim 12, wherein the parameter generation unit further provides first, second and third parameters and the preview screen generation unit further determines a maximum value of the N according to the resolution of the touch-sensitive display unit and the first parameter; and determines the value of the level number M according to the video length of the video, the second parameter and the third parameter, wherein the first parameter represents an expected resolution, the second parameter represents a minimum expected gap between each two of the N video frames and the third parameter represents a maximum expected gap between each two of the N video frames.

14. The video-previewing system of claim 13, wherein the preview screen generation unit further obtains a first count value according to the video length of the video and the second parameter and determines whether the first count value has exceeded the maximum value of the frame number N preview screen generation unit, wherein when the first count value has not exceeded the maximum value of the frame number N, the preview screen generation unit determines the value of the level number M is set to be 1 and sets the value of the frame number N to the first count value; and when the first count value has exceeded the maximum value of the frame number N, the preview screen generation unit further obtains a second count value according to the video length of the video and the third parameter and determines whether the second count value has exceeded the maximum value of the frame number N, and determines the value of the level number M is set to be 1 and setting the value of the frame number N to the second count value when the second count value has not exceeded the maximum value of the frame number N.

15. The video-previewing system of claim 14, wherein the preview screen generation unit further determines the value of the level number M is set to be at least 2 and sets the value of the frame number N for a first level frame bar among the M level frame bars to the maximum value of the frame number N when the second count value has exceeded the maximum value of the frame number N.

16. The video-previewing system of claim 15, wherein the maximum value of the level number M is set to be 3.

17. The video-previewing system of claim 15, wherein the preview screen generation unit further divides the video into the N video frames based on the video length of the video, obtains a third count value according to a frame length of each of the N frames and the second parameter and determines whether the third count value has exceeded the maximum value of the frame number N;
wherein when the third count value has not exceeded the maximum value of the frame number N, the preview screen generation unit determines the value of the level number M is set to be 2 and sets the value of the frame number N for a second level frame bar among the M level frame bars to the third count value; and
when the third count value has exceeded the maximum value of the frame number N, the preview screen generation unit obtains a fourth count value according to the video length of the video and the third parameter and determines whether the fourth count value has exceeded the maximum value of the frame number N; and when the fourth count value has not exceeded the maximum value of the frame number N, the preview screen generation unit further determines the value of the level number M is set to be 2 and sets the value of the frame number N for the second level frame bar among the M level frame bars to the fourth count value.

18. The video-previewing system of claim 17, wherein the preview screen generation unit further determines the value of the level number M is set to be 3 and sets the value of the frame number N for the second level frame bar among the M level frame bars to the maximum value of the frame number N when the fourth count value has exceeded the maximum value of the frame number N.

19. The video-previewing system of claim 18, wherein the preview screen generation unit further divides the video frame into N sub-frames based on the video length of the video, obtains a fifth count value according to a sub-frame length of each of the N sub-frames and the second parameter and determines whether the fifth count value has exceeded the maximum value of the frame number N;
wherein when the fifth count value has not exceeded the maximum value of the frame number N, the preview screen generation unit determines the value of the level number M is set to be 3 and sets the value of the frame number N for a third level frame bar among the M level frame bars to the fifth count value;
when the fifth count value has exceeded the maximum value of the frame number N, the preview screen generation unit obtains a sixth count value according to the sub-frame length and the sixth parameter and determines whether the sixth count value has exceeded the maximum value of the frame number N; and when the sixth count value has not exceeded the maximum value of the frame number N, the preview screen generation unit further determines the value of the level number M is set to be 3 and setting the third level frame bar among the M level frame bars to the sixth count value;
wherein the preview screen generation unit further determines the third level frame bar among the M level frame bars according to an unconditional cutting or an unconditional rounding-up method when determining that the value of the level number M is set to be 3.

20. A non-transitory machine-readable storage medium comprising a computer program, which means for driving a device to perform a video-previewing method for providing preview of a video to be played, wherein the device includes a touch-sensitive display unit and the video-previewing method comprises the steps of:
detecting a resolution of the touch-sensitive display unit; and
generating a preview screen corresponding to the video on the touch-sensitive display unit according to the resolution of the touch-sensitive display unit detected by the parameter generation unit,
wherein the preview screen includes M level frame bars and each of the M level frame bars displays N video frames, wherein the value of the frame number N of video frames for each of the M level frame bars is determined based on the resolution of the touch-sensitive display unit, where M≧1 and N≧1.
